(19) United States
(12) Patent Application Publication
(10) Pub. No.: US 2025/0379487 A1
(43) Pub. Date: Dec. 11, 2025

(54) RADIAL ACTUATOR ROUTING SUPPORT AND ASSOCIATED MAGNETIC BEARING MODULE

(71) Applicant: SKF Magnetic Mechatronics, Saint-Marcel (FR)

(72) Inventors: Eduardo CARRASCO, Saint Etienne sous Bailleul (FR); Julien VAUBY, Rouen (FR); Nicolas POLO, Taverny (FR); Eddy HERISSE, les Andelys (FR)

(21) Appl. No.: 19/226,231

(22) Filed: Jun. 3, 2025

(30) Foreign Application Priority Data
Jun. 10, 2024 (FR) FR2406075

(51) Int. Cl. H02K 7/09

(52) U.S. Cl. CPC H02K 7/09

(57) ABSTRACT

A routing support (1) for a cable (2). The routing support is intended to be assembled onto a radial actuator (4) for a magnetic bearing module (5). The radial actuator (4) for a magnetic bearing module (5) includes an arrangement of coils disposed around a central axis and an insulation displacement contact (7). The routing support (1) includes a routing track for the cable (2) and openings (3) enabling insertion of said cable (2) in the insulation displacement contact (7) through some of the openings (3) when the routing support (1) is positioned facing said radial actuator (4). The routing track is formed on two opposite faces of the routing support (1) by at least one plurality of protuberances and/or serigraphs defining bearing surfaces for said cable (2) for routing it along the routing support (1).

### CROSS-REFERENCE TO RELATED APPLICATOIN

This application claims priority to French Application No. FR2406075, filed Jun. 10, 2024, the entirety of which is hereby incorporated by reference.

### FIELD

The present disclosure concerns a magnetic bearing module that includes a radial actuator.

The present disclosure aims to constitute a magnetic bearing module that includes a routing support for a radial actuator.

### BACKGROUND

A magnetic bearing module in a system, such as an industrial machine, typically includes a radial actuator, one or more other actuators, and a position sensor.

Routing the cables on a support coupled with crimping these cables using an insulation displacement contact allows the circuit of a radial actuator for a magnetic bearing to be created quickly and easily while guaranteeing electrical isolation.

To meet the aforementioned conditions, two wiring methods are typically used: connections made manually, known as splices, or using a printed circuit board (PCB).

The method of manually splicing enameled wires to cables or enameled wires to each other requires intermetallic soldering, an insulation step, and a manual mechanical positioning step, followed by one or more varnish impregnations for bonding and electrical insulation of the assembly, then cleaning of the mechanical interfaces for positioning the assembly in a magnetic bearing module.

This method cannot be automated, and is therefore difficult to replicate, laborious, and unreliable.

The PCB method, in which the enameled wires can be soldered directly to the printed circuit board or to a pin passing through the board, requires that the cables can also be soldered directly or via a connector with through-hole pins, all of which must be held in place with screw or crimped fasteners, and generally additional overmoulding for mechanical protection and/or electrical insulation.

This method is particularly costly because it requires complex production steps and tools, and prevents modular design of the production tools, which are specific to one PCB design.

The present disclosure aims to propose a magnetic bearing module whose assembly can be carried out on an automated line in a robotic station, significantly reducing the time to produce the module, while allowing dimensional adaptation of the production tools according to the desired dimensions of the magnetic bearing modules.

The present disclosure also eliminates the need for overmoulding or impregnation for additional mechanical and/or electrical protection of the PCB to which the enameled winding wire is directly soldered or connected, operations that are time-consuming and delicate due to the use of chemicals and the time needed for baking and cleaning.

### SUMMARY

The present disclosure has for object alleviating at least some of the aforementioned drawbacks and proposing a cable routing support for a radial actuator for a magnetic bearing module that is rapid, simple and reliable over a wide range of magnetic bearing dimensions.

Given the foregoing, the present disclosure has for object a routing support for a cable, intended to be assembled onto a radial actuator for a magnetic bearing module. The radial actuator for a magnetic bearing module includes an arrangement of coils disposed around a central axis and an insulation displacement contact. The routing support includes a routing track for the cable and openings configured to enable insertion of the cable in the insulation displacement contact through some of the openings when the routing support is positioned facing the radial actuator for the magnetic bearing module. The routing track is formed on two opposite faces of the routing support by at least one plurality of protuberances and/or serigraphs configured to define bearing surfaces for the cable for routing it along the routing support.

This routing track simplifies the radial actuator production process by using standard insulation displacement contacts, precise coil positioning with keying, and a lightweight, easy-to-implement cable routing support that eliminates the need for complex chemical processes, improves the thermal and chemical resistance of the cable and the coils of the module, and enables faster and more environmentally friendly modular production with limited error risk.

Above all, this method of pre-wiring the routing support coupled with the insulation displacement contact technology drastically reduces the time required for the very time-consuming connection steps, making the production process more reliable and automatable but above all flexible to demand since the production of this support, which is modular in terms of length and cable dimensions, makes it possible to increase the number of references compatible with the same support for more or less lengthy wiring installed in the same way on this support.

The routing support preferably includes at least one notch forming a passage for the cable from one face to the other of the routing support. Such a notch enables correct and reliable positioning of the cable as it passes from face to the other of the routing support.

The notch advantageously has a variable section in such a manner as to retain the cable by squeezing it. Such a configuration further improves correct and reliable positioning of the cable as it passes from one face to the other of the routing support.

The routing support preferably includes at least one retaining slot configured to retain the cable by squeezing it for its insertion in the insulation displacement contact through the opening. Such a retaining groove favours correct positioning of the cable during its insertion into the insulation displacement contact through the opening, thus facilitating assembly of the routing support onto the radial actuator.

For example, the routing support includes two retaining slots placed on respective opposite sides of the opening. Such a configuration guarantees optimal positioning of the cable.

The routing support advantageously includes clipping hooks intended to cooperate with locking lugs on the radial actuator. Such a configuration guarantees retention of the assembly of the routing support on the radial actuator.

In another aspect, the present disclosure has for object an assembly comprising a routing support as defined hereinabove and a cable disposed on the routing track of the routing support. Such a prewired assembly simplifies the production process.

In another aspect, the present disclosure has for object a magnetic bearing module including a radial actuator coupled to the magnetic bearing and an assembly as defined hereinabove assembled onto the radial actuator.

The cable of the magnetic bearing module is preferably retained by squeezing it during its insertion in the insulation displacement contact.

The insulation displacement contact is advantageously housed at least in part in the opening that enables insertion of the cable in the insulation displacement contact. This configuration favours retention of the cable in position and correct relative positioning of the routing support of the radial actuator.

### BRIEF DESCRIPTION OF THE DRAWINGS

The present disclosure will be better understood after detailed study of one embodiment that is depicted by way of non-limiting and illustrative example in the appended drawings, in which:

FIG. 1 is a view from above of an assembly according to the present disclosure including a routing support and cables,

FIG. 2 is a view from below of the FIG. 1 assembly,

FIG. 3 is a detail view of a part of the FIG. 2 assembly,

FIG. 4 is a perspective view from the front of a magnetic bearing module including the FIG. 1 assembly assembled onto a radial actuator, separately from the magnetic bearing module,

FIG. 5 is a perspective view from the rear of the FIG. 4 magnetic bearing module,

FIG. 6 is a detail view of a part of the FIG. 5 magnetic bearing module,

FIG. 7 is a view from above of the FIG. 4 magnetic bearing module,

FIG. 8 is a view in section taken along the line VIII-VIII in FIG. 7, before assembly, and

FIG. 9 is a view in section taken along the line IX-IX in FIG. 7, before assembly.

### DETAILED DESCRIPTION

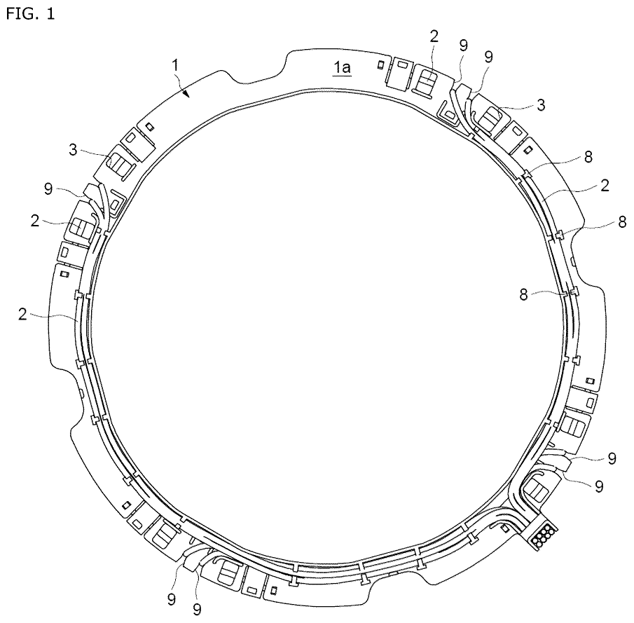

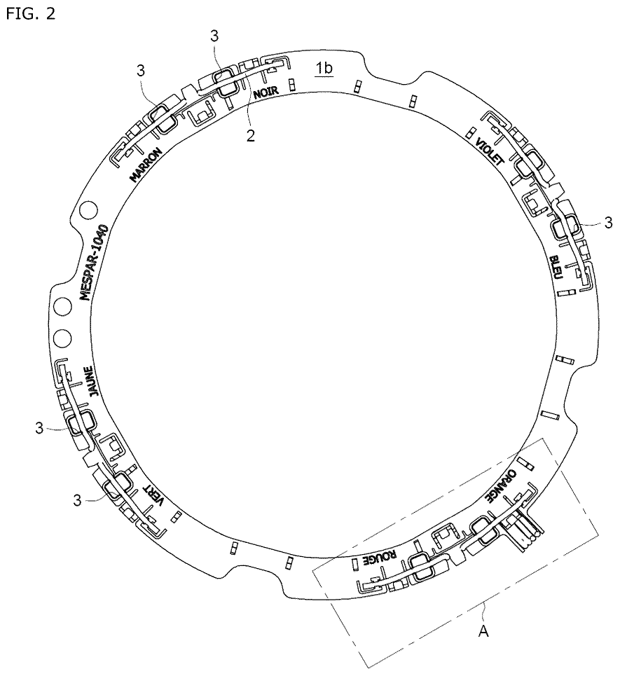

As represented in FIGS. 1 to 3 a routing support 1 according to the present disclosure for a cable 2 includes a routing track for the cable 2 and openings 3.

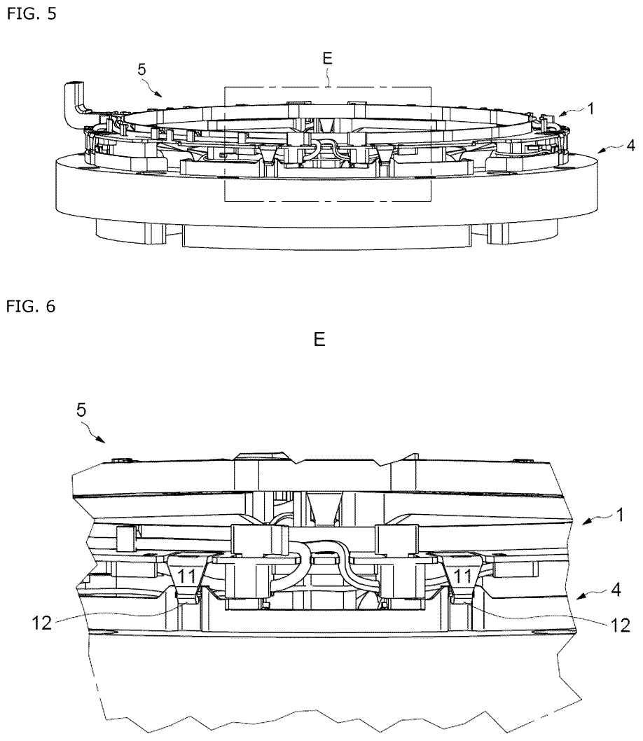

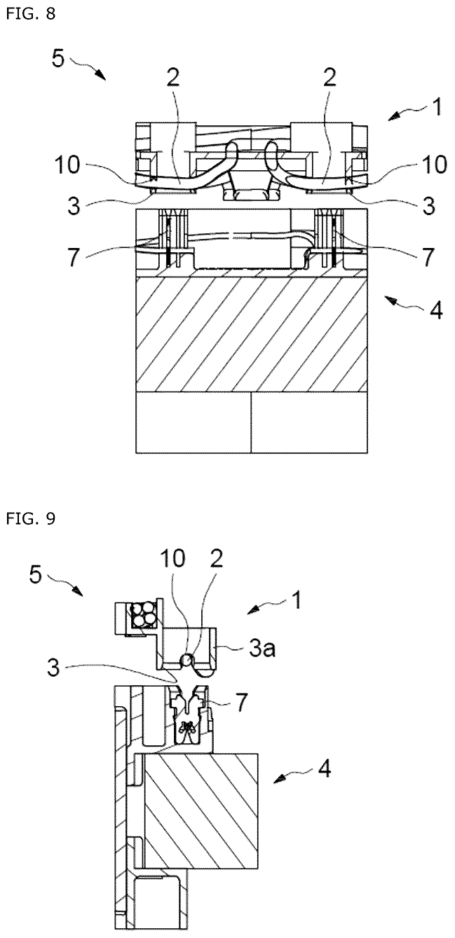

The routing support 1 is configured to be assembled onto a radial actuator 4 for a magnetic bearing 5 (FIGS. 4 and 5). The radial actuator 4 includes an arrangement of coils 6 disposed around a central axis X and an insulation displacement contact 7 seen in particular in FIGS. 8 and 9. It is to be noted that identical or similar elements bear the same references from one figure to another.

The openings 3 are configured to allow insertion of the cable 2 in the insulation displacement contact 7 through some of the openings 3 when the routing support 1 is positioned facing the radial actuator 4.

Each opening 3 is formed on the routing support 1 by open protuberances 3a disposed on a rear face 1b of the routing support 1. Each opening 3 is of rectangular shape for example so as to accommodate the shape of the insulation displacement contact 7.

The routing track for the cable 2 is formed on two opposite sides of the routing support 1, namely on the rear face 1b and on a front face 1a. The routing track for the cable 2 is formed by at least one plurality of protuberances 8 and/or serigraphs configured to delimit bearing surfaces for the cable 2 for routing it along the routing support 1. The opposite faces 1a, 1b delimit the thickness of the routing support 1. The protuberances 8 and/or serigraphs are arranged to form the routing track, which extends over all or part of the circumference of the plate formed by the routing support 1.

The protuberances 8 and/or serigraphs of each routing track are for example spaced relative to one another over the circumference of the plate formed by the routing support 1, which makes it possible to limit the quantity of material used and to reduce the weight of the part.

The protuberances 8 and/or serigraphs for each track are preferably arranged so as to retain the cable 2 by two of its sides, which enables optimal retention despite the successive different orientations of the cable 2.

By “cable 2” is interchangeably meant one or more flexible cables passing in or intended to pass in the routing track and including, for example, an enamelled wire and/or a multistrand cable.

The routing support 1 can include a plurality of routing tracks for a plurality of cables 2 and the protuberances 8 and/or serigraphs of each routing track are arranged so as to retain the cable 2 disposed on this routing track laterally and on its two sides.

The protuberances 8 are for example complemented by serigraphs projecting on the same face of the routing support 1 to assist routing the cable 2 along the routing support 1.

There is therefore formed an assembly comprising a routing support 1 and a cable 2 disposed on the routing track of the support, the length of which can be adapted when it is installed on the routing support 1 without altering the efficacy of this step of producing a magnetic bearing module 5.

Such a magnetic bearing module 5 has the advantage of making it easy to reduce the number of variants of the design of the routing support 1, unlike prior art modules including a fixed printed circuit in which it is not possible to modify the length of the electrical connections from the printed circuit to the exterior system.

The routing support 1 therefore makes it possible to have a cable 2 or a bundle of cables 2 of the required final length already equipped with its connectors as a function of the required version and therefore to have varied lengths and connector references, whereas the systems known from the prior art do not allow modular cable lengths.

This routing support 1 equipped with a routing track is modular since it can be mounted on any support having the same interfaces, namely the same distances between the axes of the pins and the same positions of the coils 6 and the insulation displacement contacts 7.

Since the coils 6 are common to substantially all sizes this routing support 1 can also be produced homothetically with different sizes to adapt to what is required, retaining the ratio of the insulation displacement contacts 7 and adapting the routing.

The routing support 1 advantageously includes at least one notch 9 formed on the exterior surface of the routing support 1 and forming a passage for the cable 2 leading from one face 1a, 1b of the routing support 1 to the other.

The notch 9 preferably has a varying section that decreases in the radial direction toward the interior of the routing support 1 so as to retain the cable 2 by squeezing it. Here, the notches 9 have a Y-shaped section. Alternatively, it remains possible to use varying sections having other shapes.

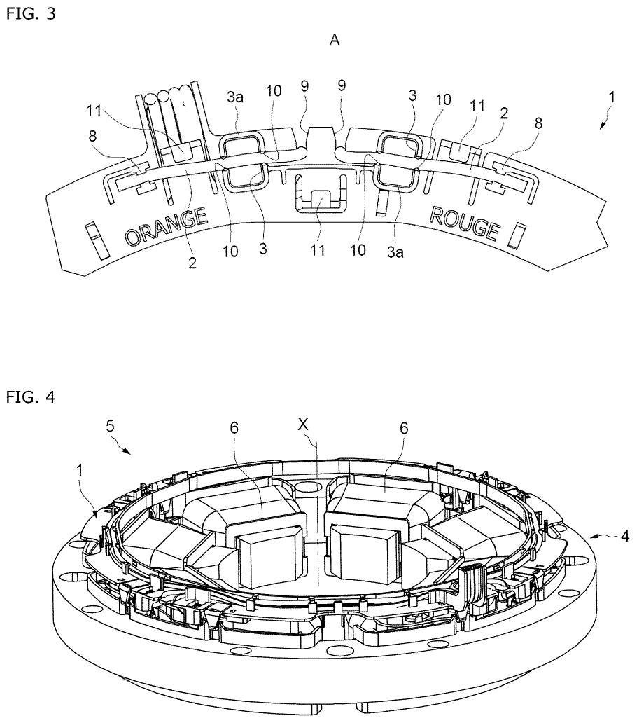

As can be seen in FIG. 3 in particular, the routing support 1 includes at least one retaining slot 10 configured to retain the cable 2 by squeezing it in order to insert it in the insulation displacement contact 7 through the opening 3.

The slots 10 enable the cable 2 to be squeezed to guarantee its positioning and retention during its insertion in the insulation displacement contact 7.

The routing support 1 includes for example two retaining slots 10 placed on either side of the opening 3 on the protuberances 3a delimiting the opening 3 so as to retain the cable 2 on either side of the insulation displacement contact 7 in a manner that is symmetrical and therefore precise, stable, durable and reliable.

As can be seen in FIG. 6 in particular the routing support includes clipping hooks 11 intended to cooperate with locking lugs 12 on the radial actuator 4. Such clipping means enable robust fixing of the routing support 1 on the radial actuator 4 and guarantee the integrity of the connections during subsequent assembly and/or storage phases.

The coils 6 of the radial actuator 4 are positioned around a substantially concentric circular assembly at precise radial distances relative to the centre of the circular assembly and also at precise angular positions, since such positioning makes it possible to place the insulation displacement contact 7 at strategic locations to receive the cable 2 to which the electrical connection to the coils 6 must be made.

The radial actuator 4 can therefore include a plurality of insulation displacement contacts 7 and cables 2 connected to one or more routing tracks of the routing support 1.

The cable 2 can also include at least in part the wire that is wound onto each spool to form the coils 6 and then routed to at least one opening 3 to make a connection to an insulation displacement contact 7 by insertion therein.

The routing track therefore enables each cable 2 to be routed along the intended path thanks to the shapes on the routing support 1.

The routing support 1 is for example a plastic part including shapes and extrusions formed for example by screenprinting to obtain the routing track and facilitate its production.

Such a routing track enables good guidance of each cable 2 and reduces crossover errors.

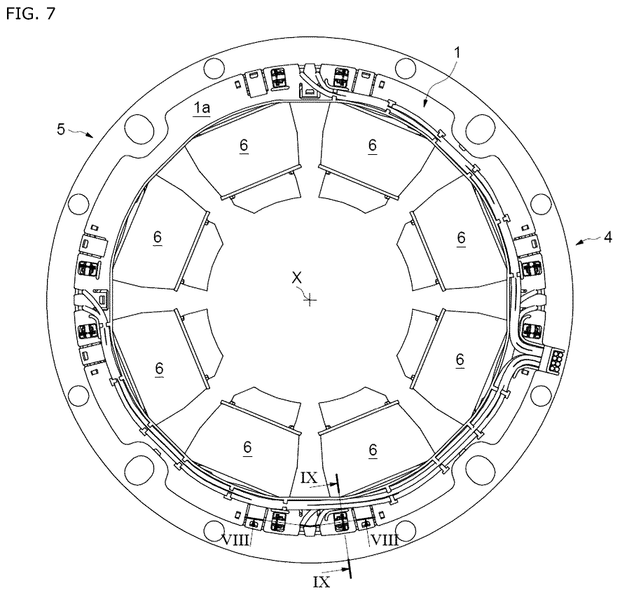

FIGS. 4 to 7 depict a magnetic bearing module 5 including a prewired routing support 1 assembled onto a radial actuator 4. The magnetic bearing module 5 includes a position sensor (not represented) to which the radial actuator 4 is coupled.

FIGS. 8 and 9 are views in section of the magnetic bearing module 5 before assembling the prewired routing support 1 onto the radial actuator 4. Before assembly the routing support 1 is positioned facing the radial actuator 4 for the magnetic bearing module 5.

As indicated above the cable 2 is retained by squeezing it by means of the retaining slots 10 during its insertion in the insulation displacement contact 7.

After assembly the insulation displacement contact 7 is housed at least in part in the opening 3 that enables insertion of the cable 2 in the insulation displacement contact 7.

The routing support 1 provides support and mechanical protection of the circuit formed by the routing track for routing the cable 2 against possible environmental attack during the life of the magnetic bearing module 5 or during the various operations to produce it.

The routing support 1 also makes it possible to retain the cable 2 and the coils 6 in their operational position throughout the life of the module 5, guaranteeing that electrical insulation distances are maintained in accordance with predefined rules.

What is claimed is:

1. A routing support for a cable and to be assembled onto a radial actuator for a magnetic bearing module, the radial actuator including an arrangement of coils disposed around a central axis and an insulation displacement contact, the routing support comprising:
a routing track for the cable, the routing track being formed on two opposite faces of the routing support by at least one plurality of protuberances and/or serigraphs configured to define bearing surfaces for said cable for routing the cable along the routing support; and
openings configured to enable insertion of said cable in the insulation displacement contact through some of the openings when the routing support is positioned facing said radial actuator for the magnetic bearing module.

2. The routing support according to claim 1, further comprising at least one notch forming a passage for the cable from one face to the other face of said routing support.

3. The routing support according to claim 2, wherein the at least one notch has a variable section in such a manner as to retain the cable by squeezing the cable.

4. The routing support according to claim 1, further comprising at least one retaining slot configured to retain the cable by squeezing the cable for its insertion in the insulation displacement contact through the opening.

5. The routing support according to claim 4, wherein the at least one retaining slot includes two retaining slots placed on respective opposite sides of the opening.

6. The routing support according to claim 5, further comprising clipping hooks configured to cooperate with locking lugs on the radial actuator.

7. The routing support according to claim 3, further comprising at least one retaining slot configured to retain the cable by squeezing the cable for its insertion in the insulation displacement contact through the opening.

8. The routing support according to claim 7, wherein the at least one retaining slot includes two retaining slots placed on respective opposite sides of the opening.

9. The routing support according to claim 8, further comprising clipping hooks configured to cooperate with locking lugs on the radial actuator.

10. An assembly comprising:
the routing support according to claim 1; and
the cable disposed on said routing track of the routing support.

11. A magnetic bearing module comprising:
a magnetic bearing;
the assembly according to claim 10; and
the radial actuator,
wherein the radial actuator is coupled to the magnetic bearing and the assembly is assembled onto the radial actuator.

12. The magnetic bearing module according to claim 11, wherein the cable is retained by squeezing the cable during its insertion in the insulation displacement contact.

13. The magnetic bearing module according to claim 11, wherein the insulation displacement contact is housed at least in part in the opening that enables insertion of the cable in the insulation displacement contact.

14. An assembly comprising:
the routing support according to claim 9; and
the cable disposed on said routing track of the routing support.

15. A magnetic bearing module comprising:
a magnetic bearing;
the assembly according to claim 14; and
the radial actuator,
wherein the radial actuator is coupled to the magnetic bearing and the assembly is assembled onto the radial actuator.

16. The magnetic bearing module according to claim 15, wherein the cable is retained by squeezing the cable during its insertion in the insulation displacement contact.

17. The magnetic bearing module according to claim 16, wherein the insulation displacement contact is housed at least in part in the opening that enables insertion of the cable in the insulation displacement contact.
